(19) United States
(12) Patent Application Publication
(10) Pub. No.: US 2004/0264310 A1
(43) Pub. Date: Dec. 30, 2004

(54) Optical head device

(76) Inventor: Yoshio Hayashi, Suwa-gun (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/830,650

(22) Filed: Apr. 23, 2004

(30) Foreign Application Priority Data
Apr. 24, 2003 (JP) 2003-119556

(51) Int. Cl. G11B 7/00

(52) U.S. Cl. 369/44.14; 369/44.22

(57) ABSTRACT

An optical head device has a holder support member supporting a lens holder. A combination of tracking and focusing drive coils, and drive magnets are used to move the lens holder in the tracking and focusing directions. A pair of corrective magnets are positioned on two sides of the lens holder in the tracking direction so as to form an open magnetic path. When the focusing drive coil is opposed to the drive magnets to displace the lens holder in the tracking direction, the focusing drive coil is also opposed to the pair of corrective magnets in order to prevent a tilting of the lens in the lens holder. Thus, the position of the lens holder can be maintained simply and inexpensively by using the pair of corrective magnets configured to provide an open magnetic path.

### TECHNICAL FIELD

The present invention relates to an optical head device that is used for the recording and reproducing of optical recording media such as CDs and DVDs. More specifically, it relates to an objective lens driving mechanism for supporting an objective lens to move in a tracking direction and in a focusing direction.

### BACKGROUND OF THE INVENTION

For an optical head device which is used for recording and reproducing information on optical recording media such as CDs and DVDs, a wire suspension method or a shaft-moving method is known in which a lens holder holding an objective lens is supported by wires or a fixed shaft to move in a tracking direction and in a focusing direction. The optical head device with either one of the above methods comprises a lens holder holding an objective lens, a lens holder support member for supporting the lens holder, and a magnetic driving mechanism for driving the lens holder in the tracking direction and in the focusing direction. The magnetic driving mechanism has a focusing drive coil and a tracking drive coil on the side surfaces of the lens holder and also has tracking/focusing drive magnets provided on the lens holder support member.

FIG. 7 shows a major portion of an objective lens driving mechanism in an optical head device with a wire suspension method. A lens holder 101 holding an objective lens 100 is fixed in the following manner. Four wires 102, 103, 104 and 105 for supporting the lens holder 101 to move in the tracking direction, Tr, and in the focusing direction, Fo, are paired; the base ends thereof are fixed to the lens holder support member and the other ends thereof are fixed two on each side of the lens holder 101 in the tracking direction. Through the wires 102, 103, 104 and 105, the focusing drive coil 106 and the tracking drive coil 107 are charged with a predetermined electric current.

The lens holder 101 is formed to be cubical. The focusing drive coil 106 is wound in a loop around the body of the lens holder 101 obtaining four sides. To one of the two opposing sides 108, a tracking/focusing drive magnet 109 is opposed. Also, on the two opposing sides 108, a pair of tracking drive coils 107 are arranged to oppose the tracking/focusing drive magnet 109. When the focusing drive coil 106 and the tracking drive coils 107 are charged with a predetermined electric current through the four wires 102, 103, 104 and 105, the lens holder 101 holding the objective lens 100 is driven in the tracking direction, Tr, and in the focusing direction, Fo.

When the focusing drive coil 106 is charged with a predetermined electric current to move the lens holder 101 in the focusing direction, Fo, the focusing drive coil 106 is moved upward as indicated by the arrow in FIG. 7 due to a magnetic interaction with the tracking/focusing drive magnet 109.

When the tracking drive coils 107 are charged with an electric current according to the control signal, the lens holder 101 is moved to the left by a distance, a, as shown in FIG. 8. Under this condition, if the focusing drive coil 106 is electrified with an electric current, the coil 106 moves upward. However, since the center of the focusing drive coil 106 has been shifted to the left, a drive force is generated on the coil 106 to raise the right side of the coil 106. Particularly, in an optical head device with a wire suspension method wherein the lens holder 101 holding the objective lens 100 is supported by the wires 102, 103, 104 and 105, the lens holder 101 shifts from the original position shown by two-dotted line to the inclined position shown by a solid line. Therefore, a tilt angle θ is generated on the optical axis 111 of the objective lens 100.

Under the condition where a tilt angle θ is generated on the objective lens 100, the focusing direction, Fo, is displaced as well as the tracking direction, Tr; thus, focusing errors and tracking errors occur. Therefore, this requires a complicated, highly precise control with a greatly increased responsive speed to move the objective lens 100 in the focusing direction, Fo, and the tracking direction, Tr, for correction.

Therefore, it would be desirable to provide an optical head device with a simple configuration, in which the optical axis of an objective lens can be maintained in a fixed position even when a lens holder is driven in the tracking direction.

### SUMMARY OF THE INVENTION

To achieve the above objective, an optical head device of the present invention comprises a lens holder for holding an objective lens which converges a light beam emitted by a light source onto an optical recording medium, a holder support member for supporting the lens holder to move in a tracking direction and in a focusing direction, a tracking drive coil and a focusing drive coil which are arranged in the lens holder, and drive magnets which are arranged to oppose the drive coils to configure a magnetic drive circuit together with the drive coils; wherein while the focusing drive coil is opposed to the drive magnets, it is also opposed to a pair of corrective magnets which are arranged on both ends of the lens holder in the tracking direction to configure a open magnetic path.

According to the optical head device of the present invention, a pair of corrective magnets which configures an open magnetic path are arranged on both sides of the focusing drive coil in the tracking direction to oppose each other. Therefore, even when the focusing drive coil is electrified after the lens holder has been moved in the tracking direction, the lens holder is corrected by a magnetic interaction between the focusing drive coil and a closer corrective magnet so that it is moved in the same direction as the focusing direction. With this, an optical axis of the objective lens can be maintained in a fixed position. Also, since the corrective magnets are configured as an open magnetic path, the correcting power varies depending on the distance from the focusing drive coil. Therefore, the position of the lens holder can be properly corrected according to the distance the lens holder moved in the tracking direction. Further, simply a pair of corrective magnets are arranged to oppose each other, and thus the objective lens driving mechanism can be configured to be simple at an inexpensive cost.

In the optical head device of the present invention, the focusing drive coil is wound in loop to obtain four sides, and the drive magnets are arranged to oppose at least one of the four sides and a pair of the corrective magnets are arranged to oppose the two sides which are perpendicular to the said one side.

According to the optical head device of the present invention the focusing drive coil is wound in a loop to obtain four flat sides. For this reason, even when the lens holder is driven in the tracking direction by the tracking drive coil, a magnetic interaction between the drive magnets and the corrective magnets, which are facing the surface, can be maintained evenly.

In the optical head device of the present invention, the drive magnets and a pair of the corrective magnets are arranged such that the center of the opposing surfaces is aligned with the drive center of the focusing drive coil under the non-driven condition.

According to the optical head device of the present invention, the center of the opposing surfaces of the drive magnets and a pair of the corrective magnets coincide with the center of the focusing drive coil under the non-driven condition. With this configuration, even when the lens holder is moved in the tracking direction, a magnetic interaction between the drive magnets and the corrective magnets, which are opposed to the focusing drive coil surface, can be maintained to exert force evenly on both members, thus preventing asymmetrical correction of the focusing drive coil.

In the optical head device of the present invention, the lens holder is supported by a plurality of wires having predetermined spring constants to move in the tracking direction and in the focusing direction.

Since an optical head device with a wire suspension method, wherein the lens holder holding the objective lens is supported by a plurality of wires, is not equipped with a mechanism for maintaining an optical axis of the objective lens in a fixed position, the lens holder inclines according to the distance of its movement in the tracking direction and a tilt angle θ is generated on the optical axis of the objective lens. However, according to the optical head device of the present invention, the position of the lens holder can be corrected by a magnetic interaction with the closer corrective magnet so that the lens holder moves in the same direction as the focusing direction. Therefore, the optical axis of the objective lens of the optical head device having a wire suspension method can be maintained in a fixed position.

### BRIEF DESCRIPTION OF THE DRAWINGS

FIG. 1 is a perspective view of an objective lens driving mechanism of an optical head device of the first embodiment of the present invention.

FIG. 2 is a plan view of the objective lens driving mechanism illustrated in FIG. 1.

FIG. 3 is a front view of the optical head device of the embodiment of the present invention.

FIG. 4(A) and FIG. 4(B) describe operations of the optical head device of the embodiment of the present invention.

FIG. 5 is a perspective view of an objective lens driving mechanism of an optical head device of the second embodiment of the present invention.

FIG. 6 is a perspective view of an objective lens driving mechanism of an optical head device of the third embodiment of the present invention.

FIG. 7 is a front view of a major portion of a conventional optical head device.

FIG. 8 is a front view showing the abnormal condition of the optical head device of FIG. 5.

### DETAILED DESCRIPTION OF THE INVENTION

An embodiment of the optical head device of the present invention is described hereinafter based on the drawings.

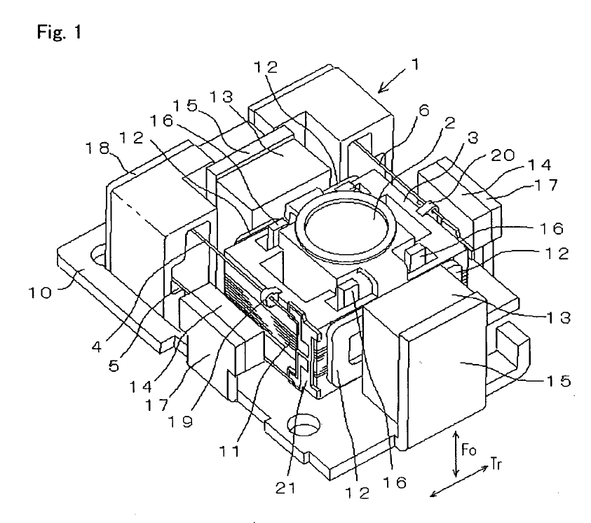

An optical head device is used for recording and reproducing information with respect to optical recording disks such as CDs and DVDs. It is configured such that a laser light beam emitted by a laser light source is reflected on a half mirror and converged through an objective lens to focus on an information-recording surface of an optical recording disk. The light beam reflected on the optical recording disk passes through the objective lens and the half mirror and enters a photo detector. The information reproducing process is performed based on the photo signals that the photo detector has detected. Also, based on the output signals from the photo detector, the objective lens driving mechanism is driven to servo-control the position and angle of the objective lens in the tracking direction and the focusing direction and also the laser light source is driven. The objective lens is driven by an objective lens driving mechanism of a wire suspension method as shown in FIG. 1.

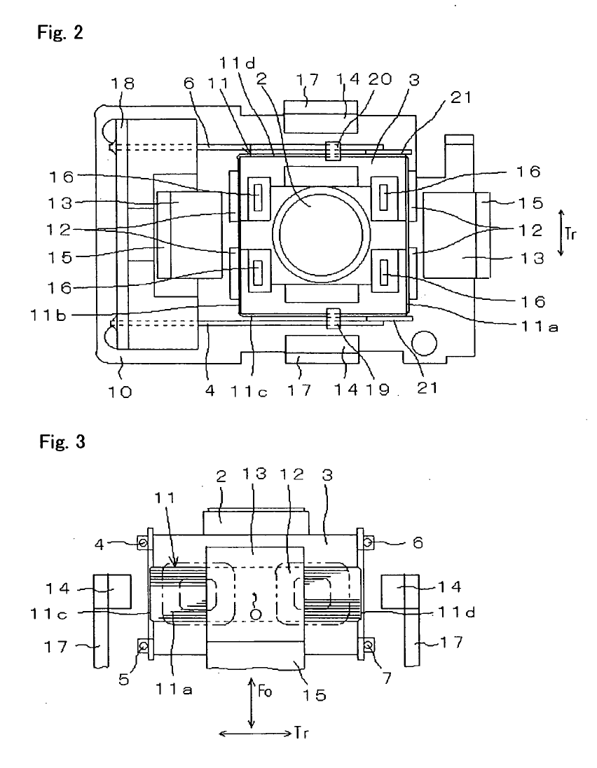

FIG. 1 illustrates a perspective drawing of the first embodiment of an objective lens driving mechanism of an optical head device of the present invention, and FIG. 2 illustrates a plan view of the first embodiment. An objective lens driving mechanism 1 comprises a lens holder 3 holding an objective lens 2, a holder support member 10 which supports the lens holder 3 with four wires 4, 5, 6 and 7 (the wire 7 is not illustrated in the figure), and a magnetic driving mechanism which drives the lens holder 3 in a tracking direction shown by an arrow, Tr, and in a focusing direction shown by an arrow, Fo. The wires 4, 5, 6 configure an electric current path to electrify a focusing drive coil 11 and a tracking drive coil 12 which will be described later.

The magnetic driving mechanism has a focusing drive coil 11 which is wound around a body portion of the lens holder 3, which is centered around the optical axis of the objective lens 2, and a tracking drive coil 12 composed of four flat coils attached to the outer surface of the focusing drive coil 11. The lens holder 3 is formed to be cubical as illustrated in the figure, and the focusing drive coil 11 is wound around the body portion thereof. Thus, this configures the focusing drive coil 11 to have four flat sides. To the two opposing sides 11a and 11b, a pair of tracking/focusing drive magnets 13 are opposed. Also, to the other two opposing sides 11c and 11d which are perpendicular to the two opposing sides 11a and 11b, a pair of corrective magnets 14 provided to the holder support member 10 are opposed.

The tracking/focusing drive magnets 13 are fixed to the inner surfaces of a pair of outer yokes, which are formed upright on the bottom plate of the holder support member 10. On the holder support member 10, inner yokes 16 are formed upright at the positions inside the lens holder 3 to face the inner surfaces of the outer yokes 15.

The corrective magnets 14 are fixed to the inner surfaces of outer yokes 17 which are formed upright on the bottom plate of the holder support member 10 outside the lens holder 3 in the tracking direction, Tr. Each of the corrective magnets 14 is magnetized with N and S poles in the surface direction; one of the surfaces thereof opposing the focusing drive coil 11 is magnetized with N pole and the other with S pole.

There is no inner yoke provided to oppose the corrective magnets 14. Thus, an open magnetic path is formed to have a magnetic interaction only with the focusing drive coil 11.

In the objective lens driving mechanism 1 having such a configuration, the focusing drive coil 11 is opposed to the tracking/focusing drive magnets 13 and the corrective magnets 14; when the focusing drive coil 11 is charged with a predetermined electric current through the wires, the lens holder 3 is driven in the focusing direction, Fo.

The tracking drive coil 12 is opposed to the tracking/focusing drive magnets 13; when the tracking drive coil 12 is charged with a predetermined electric current through the wires, the lens holder 3 is driven in the tracking direction, Tr.

The lens holder 3 holding the objective lens 2 is supported by the four wires 4, 5, 6, . . . to move in the tracking direction, Tr, and in the focusing direction, Fo. The wires 4, 5, 6, . . . are paired on each outside of the lens holder 3 in the tracking direction, Tr; the wires 4 and 6 are arranged near the top surface of the lens holder 3 in the focusing direction, Fo, and the wires 5 and 7 are arranged near the bottom surface of the lens holder 3.

The wires 4, 5, 6 . . . are fixed by soldering the base ends thereof to a wiring pattern of a printed board 18 attached perpendicularly to the holder support member 10. The other ends of the wires are fixed to fixing portions 19 and 20 provided on the front side of the lens holder 3, and are further extended and connected by soldering to a wiring pattern of a printed board 21 attached to the front of the lens holder 3. The wires 4, 5, 6, . . . are composed of a metal having elasticity, such as beryllium bronze and phosphor bronze, and uses a round wire having an outer diameter of 0.08 to 1.5 mm.

As illustrated in FIG. 3, the two sides 11a and 11b of the focusing drive coil 11 are configured such that the drive center, O, of the focusing drive coil 11 in the tracking direction, Tr, under the non-driven condition is aligned with the drive center of the tracking/focusing drive magnets 13 in the tracking direction, Tr. The center of the opposing surfaces of the other two opposing sides 11c and 11d of the focusing drive coil 11 is aligned with the center of the opposing surfaces of the corrective magnets 14.

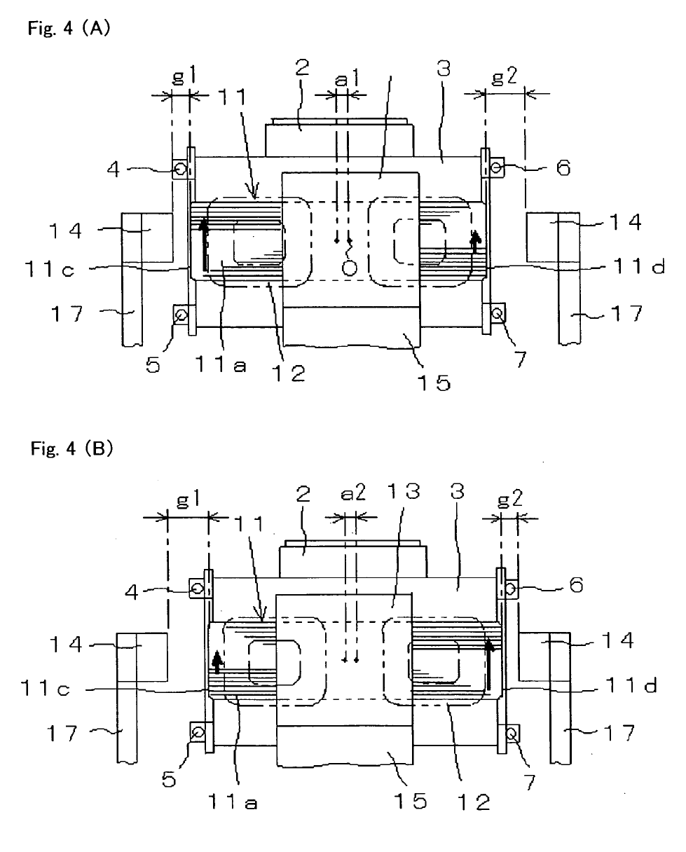

FIGS. 4(A) and (B) show operation modes of the optical head device of the present invention. FIG. 4 (A) shows the condition where the tracking drive coil 12 is charged with an electric current according to the control signal to move the lens holder 3 to the left by the distance, a1, in the tracking direction, Tr. Under this condition, when the focusing drive coil 11 is charged with an electric current according to the control signal, the lens holder 3 is driven upward.

At that time, since the center of the opposing surfaces of the focusing drive coil 11 is shifted to the left, a drive force is generated on the right side of the focusing drive coil 11, which opposes the tracking/focusing drive magnets 13, to raise (the right side of) the coil 11. Thus, the lens holder 3 tends to incline.

As the focusing drive coil 11 is shifted to the left, the left side 11c of the focusing drive coil 11 comes closer to the corrective magnet 14 on the left side, which configures an open magnetic path, and accordingly the distance, g1, becomes small. Therefore, a magnetic interaction is generated between the focusing drive coil 11 and the corrective magnet 14 by the electric current applied to the focusing drive coil 11 to raise the left side of the focusing drive coil 11. Thus, when the right side of the focusing drive coil 11 is raised, the left side thereof is also raised by the corrective magnet 14. Consequently, a focusing drive can be performed on the lens holder 3 according to the control signal without inclining it. Since the lens holder 3 is properly corrected to the right position, the optical axis of the objective lens 2 can also be corrected to the normal position.

When the lens holder 3 is moved to the left by the distance, a1, in the tracking direction Tr, the right side 11d of the focusing drive coil 11 moves away from the corrective magnet 14 (on the right side) and the distance, g2, becomes great. Even when, under this condition, the focusing drive coil 11 is charged with an electric current according to the control signal, the corrective magnet 14 (on the right side) cannot change the position of the lens holder 3 because the corrective magnet 14 has formed an open magnetic path and therefore a magnetic interaction with the corrective magnet 14 on the right side is so small as to be ignored.

Since the corrective magnets configures an open magnetic path, the magnetic interaction varies depending on the distance between the sides 11c and 11d of the focusing drive coil 11 and the corrective magnet 14. Also, since the correcting amount by the corrective magnet 14 varies depending on the moving distance of the lens holder 3 in the tracking direction Tr, a proper position of the lens holder 3 can be maintained regardless of its position in the tracking direction.

FIG. 4(B) shows the opposite condition from FIG. 4(A), wherein the tracking drive coil 12 is charged with an electric current according to the control signal to move the lens holder 3 by the distance, a2, in the tracking direction, Tr. The center of the focusing drive coil 11 is shifted to the right with respect to the tracking/focusing drive magnet 13. Under this condition, when the focusing drive coil 11 is charged with an electric current according to the control signal, a drive force is exerted on the left side of the focusing drive coil 11 to inline the lens holder 3.

At that time, the right side 11d of the focusing drive coil 11 comes closer to the corrective magnet 11 (on the right side) and the distance, g2, becomes small. Then, a magnetic interaction occurs between the coil 11 and the corrective magnet 14 to raise the right side of the focusing drive coil 11. Consequently, the tilt of the lens holder 3 is corrected by the corrective magnet 14, and the optical axis of the objective lens 2 and the lens holder 3 can be corrected to the proper position.

FIG. 4 is used to depict the way the focusing drive coil 11 is raised when the focusing drive coil 11 is charged with an electric current according to the control signal. There also is a way in which the focusing drive coil 11 can be lowered in the focusing direction, Fo. In that situation, the direction of the electric current applied to the focusing drive coil 11 is opposite from the one used to raise the coil 11. Consequently, a magnetic interaction with the corrective magnet 14 is also generated in the opposite direction. Thus, the lens holder 3 is corrected by the corrective magnet 14 according to the direction of the electric current which is applied to the focusing drive coil 11.

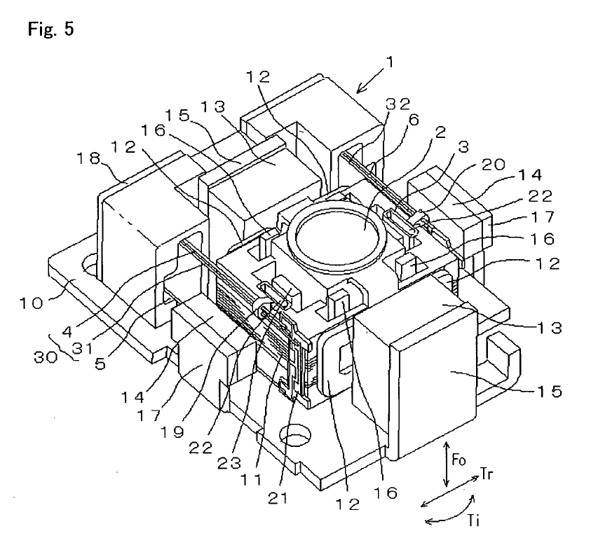

FIG. 5 shows the second embodiment of the present invention, wherein an objective lens driving mechanism can drive the lens holder 3 in the tilting direction shown by an arrow Ti. Note that the same codes are used for the same components as in the objective lens driving mechanism 1 of the first embodiment illustrated in FIGS. 1 and 2, and their descriptions are omitted.

An objective lens driving mechanism 1 illustrated in FIG. 5 supports the lens holder 3 holding the objective lens 2 with six wires and has a magnetic driving mechanism for driving the lens holder 3 in the focusing direction, Fo, and the tracking direction, Tr, and also for driving the lens holder 3 in the tilting direction shown by an arrow, Ti.

The six wires are divided in two groups: the wires 4, 5, and 31 and the wires 6, 7, and 32 (the wire 7 is not illustrated). They are arranged symmetrically about the lens holder 3 in the tracking direction. The two wires 4, 31 and 6, 32 in each group, arranged on the upper side in the focusing direction, are paired closely to configure a wire pair. The spring constant of the wire pair is established equal to that of the wire 5, 7 and is configured as a compound wire 30. The wires 31 and 32 of the wire groups are the current paths to electrify the tilting drive coils 22 that are to be described later.

A pair of tilting drive coils 22 which act as the magnetic driving mechanism are arranged symmetrically about the lens holder 3 in the tracking direction. Also, the holder support member 10 equips a pair of corrective magnets (which also functions as tilting drive magnets) 14 that oppose the tilting drive coils 22. The corrective magnets (the tilting drive magnets) 14 are fixed to the inner surfaces of the outer yokes 17 that are formed upright on the bottom plate of the holder support member 10 outside the lens holder 3 in the tracking direction, Tr. Inner yokes 23 are also formed upright on the holder support member 10 to oppose the corrective magnets (the tilting drive magnets) 14.

In the objective lens driving mechanism 1 having such a configuration, the focusing drive coil 11 is opposed to the corrective magnets (the tilting drive magnets) 14 and the tracking/focusing drive magnets 13; when the focusing drive coil 11 is charged with a predetermined electric current, the lens holder 3 is driven in the focusing direction, Fo. The tilting drive coils 22 are opposed to the corrective magnets (the tilting drive magnets) 14; when the tilting drive coils 22 are charged with a predetermined electric current through the wires 31 and 32, the lens holder 3 is driven in the tilting direction, Ti.

In other words, when the tracking drive coil 12 is first charged with an electric current according to the control signal to move the lens holder 3 in the tracking direction, Tr, and then the focusing drive coil 11 is charged with an electric current according to the control signal, the lens holder 3 is driven to move upward, for example. At that time, if the focusing drive coil 11 is shifted to either side, a drive force is exerted on the right side of the focusing drive coil 11 that opposes the tracking/focusing drive magnets 13 to raise it. Thus, the lens holder 3 tends to be inclined.

Since the focusing drive coil 11 is shifted to one side, one side of the focusing drive coil 11 comes closer to the focusing/tilting drive magnet 14a, and accordingly the distance between them becomes small. Therefore, a magnetic interaction is caused between the focusing drive coil 11 and the corrective magnets (the tilting drive magnets) 14 by the electric current applied to the focusing drive coil 11 to raise the left side of the focusing drive coil 11. Since the other side of the focusing drive coil 11 is raised by the magnetic interaction with the corrective magnets (the tilting drive magnets) 14, a focusing drive is performed on the lens holder 3 according to the control signal without inclining the lens holder.

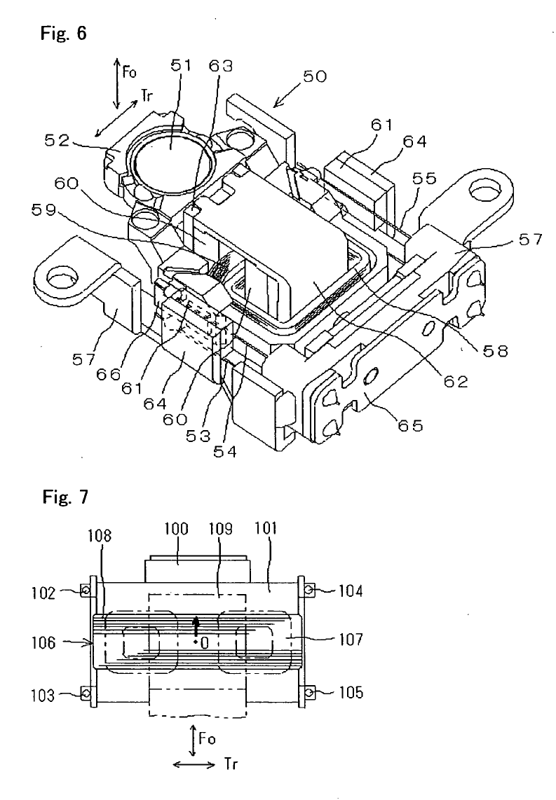

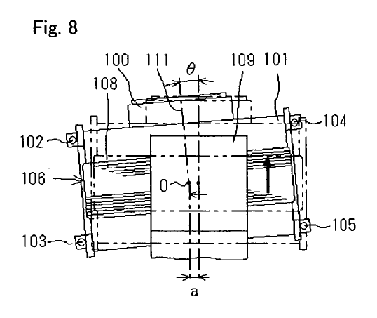

FIG. 6 illustrates the third embodiment of the present invention, wherein the present invention is applied to a thin objective lens driving mechanism. An objective lens driving mechanism 50 illustrated in FIG. 6 comprises a lens holder 52 holding an objective lens 51, a holder support member 57 which supports the lens holder 52 with four wires 53, 54, 55, and 56 (the wire 56 is not illustrated), and a magnetic driving mechanism that drives the lens holder 52 in the tracking direction shown by an arrow Tr and in the focusing direction shown by an arrow Fo. The wires 53, 54, 55 . . . are configured to be electric current paths for charging a focusing drive coil 58 and a tracking drive coil 59 that are to be described later.

The magnetic driving mechanism has a loop-like focusing drive coil 58 arranged next to the objective lens 51 in the lens holder 52 and a tracking drive coil 59 composed of a flat coil attached to the side surface of the focusing drive coil 58 on the objective lens 51 side. Since the focusing drive coil 58 is wound in a flat quadrilateral loop, the focusing drive coil 58 obtains four flat sides.

A pair of tracking/focusing drive magnets 60 are facing each other interposing one of the four sides of the coil 58 on the objective lens 51 side. Also, a pair of corrective magnets 61 arranged on the holder support member 57 are opposed to the two sides of the focusing drive coil which are perpendicular to the above one side. The tracking/focusing drive magnets 60 are fixed to the inner surface of an L-shaped inner yoke 62 and to the inner surface of a flat outer yoke 63, both of which are formed on the holder support member 57.

The corrective magnets 61 are fixed to the inner surfaces of the outer yokes 64 that are formed upright on the bottom plate of the holder support member 57 outside the lens holder 52 in the tracking direction, Tr. There are no yokes provided to oppose the corrective magnets 61. Consequently, the corrective magnets 61 are configured to be an open magnetic path so that a magnetic force is exerted only on the focusing drive coil 58.

The four wires 53, 54, 55, 56 (the wire 56 is not illustrated) supporting the lens holder 52 are fixed by soldering the base ends thereof to a printed circuit board 65 on the holder support member 57. Also, the other ends of the wires are fixed by soldering to the printed circuit boards 66 arranged on both sides of the lens holder 52 in the tracking direction, Tr. Note that the four wires 53, 54, 55, and 56 may be fixed by other known fixing means. However, since the wires are the electric current paths to electrify the focusing drive coil 58 and the tracking drive coil 59, it is necessary to provide an electrifying means to each wire even when other fixing means are used.

In the objective lens driving mechanism 50 having such a configuration, the focusing drive coil 58 are opposed to the tracking/focusing drive magnets 60 and the corrective magnets 61; when the focusing drive coil 60 is charged with a predetermined electric current through the wires, the lens holder 52 is driven in the focusing direction, Fo.

The tracking drive coil 59 is opposed to the tracking/focusing drive magnets 60; when the tracking drive coil 59 is charged with a predetermined electric current through the wires, the lens holder 52 is driven in the tracking direction, Tr.

Next, an operation of the optical head device of the third embodiment illustrated in FIG. 6 is described. When the tracking drive coil 59 is charged with an electric current according to the control signals to move the lens holder 52 to one side in the tracking direction Tr, and then the focusing drive coil 58 is charged with an electric current according to the control signal, since the drive center of the focusing drive coil 58 has been shifted with respect to the tracking/focusing drive magnets 60, a drive force is exerted on the other side of the forcing drive coil 58 to incline the lens holder 52. Thus, one side of the lens holder 52 appears to be lowered.

At that time, one side of the focusing drive coil 58 is closer to the corrective magnet 61 decreasing the space therebetween, and therefore, a magnetic interaction occurs between the focusing drive coil 58 and the corrective magnet 61. Consequently that side of the focusing drive coil 58 is raised. With this, the tilt of the lens holder 52 is corrected by the corrective magnet 61, and the optical axis of the lens holder 52 and the objective lens 51 can be corrected to the right position. In this manner, a focusing drive can be performed on the lens holder 52 according to the control signal without inclining the lens holder 52. Even when the tracking drive coil 59 is charged with an electric current according to the control signal to move the lens holder 52 to the other side in the tracking direction, Tr, the above operation can be used to correct the tilt with the corrective magnet 61.

As described above, the corrective magnets 61 are configured as an open magnetic path and magnetically react only to the focusing drive coil 58. For this reason, the lens holder 52 can be corrected according to its moving distance in the tracking direction, Tr. In other words, when the distance between the focusing drive coil 58 and the corrective magnet 61 is small, the magnetic flux density of the corrective magnet 61 exerted on the focusing drive coil 58 is large; therefore, the correction amount is large. On the other hand, when the distance is large, the magnetic flux density is small and the correction amount is also small. Thus, since the lens holder 52 can be corrected properly according to the position thereof in the tracking direction Tr, the tilt in the position of the lens holder 3 can be remarkably reduced.

Although the embodiments of the invention by the present inventors have been described in detail, the present invention is not limited to the above embodiments, but can be varyingly modified within the scope of the invention. For example, the configuration of the objective lens driving mechanism is not limited to said forms, but it may be of a shaft-sliding type wherein a lens holder is supported by a fixed shaft provided on a holder support member. With the shaft-sliding type, the tilt of the lens holder can be prevented because of its structure. However, since a predetermined clearance exists between the fixed shaft and the hole of the lens holder, a tilt within the clearance still occurs. Even for this type, the corrective magnet can be used effectively for correcting the lens holder. Although, in the above-mentioned embodiments, the lens holder is formed to be cubical and the focusing drive coil is formed in a quadrilateral loop, the lens holder may be formed to be cylindrical and the focusing drive coil may be cylindrical as well.

As described above, in the optical head device of the present invention, a pair of corrective magnets configured to be an open magnetic path are oppositely arranged on both sides of the focusing drive coil in the tracking direction, the focusing drive coil being wound around the body portion of the lens holder. Therefore, the position of the lens holder can be corrected by a magnetic interaction between the focusing drive coil and the corrective magnets. Consequently the optical axis of the objective lens can be maintained in a fixed position. Also, since the corrective magnets are configured to be an open magnetic path, the correction power varies according the distance between the corrective magnets and the focusing drive coil. Therefore, the lens holder can be corrected properly according to its moving distance in the tracking direction. Further, only one pair of corrective magnets are arranged oppositely, whereby the objective lens driving mechanism can be configured simply at an inexpensive cost.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is

1. An optical head device comprising:
a lens holder for holding an objective lens which converges a light beam emitted by a light source onto an optical recording medium;
a holder support member for supporting said lens holder to move in a tracking direction and in a focusing direction;
a tracking drive coil and a focusing drive coil which are arranged in said lens holder; and
drive magnets which are arranged to oppose said drive coils to configure a magnetic drive circuit together with said drive coils;
wherein while said focusing drive coil is opposed to said drive magnets, it is also opposed to a pair of corrective magnets which are arranged on both sides of said lens holder in said tracking direction to configure an open magnetic path.

2. The optical head device as set forth in claim 1 wherein said focusing drive coil is wound in a loop to obtain four sides; said drive magnet is arranged to oppose at least one of said four sides of said focusing drive coil and a pair of said corrective magnets are arranged to oppose two sides which are perpendicular to said one side.

3. The optical head device as set forth in claim 1 wherein said drive magnets and a pair of said corrective magnets are arranged such that the center of opposing surfaces is aligned with the drive center of said focusing drive coil under a non-driven condition.

4. The optical head device as set forth in claim 1 wherein said lens holder is supported by a plurality of wires having predetermined spring constants to move in the tracking and in the focusing directions.

5. An optical head device comprising:
a lens holder holding an objective lens that converges a light beam onto an optical recording medium;
a holder support member supporting the lens holder to allow the lens holder to move in a tracking direction and in a focusing direction; and
a magnetic drive mechanism including:
a tracking drive coil and a focusing drive coil;
drive magnets positioned to oppose the tracking and focusing drive coils to move the lens holder in the tracking and focusing directions; and
a pair of corrective magnets disposed on two sides of the lens holder in the tracking direction so as to form an open magnetic path, wherein when the focusing drive coil is opposed to the drive magnets, the focusing drive coil is also opposed to the pair of corrective magnets.

6. The optical head device as set forth in claim 5 wherein:
the focusing drive coil is wound in a loop around four sides;
the drive magnets are arranged to oppose at least one of the four sides of the focusing drive coil; and
the corrective magnets are arranged to oppose two sides which are perpendicular to the at least one side.

7. The optical head device as set forth in claim 5 wherein the drive magnets and the corrective magnets are arranged such that the center of opposing surfaces of the corrective magnets is aligned with the drive center of the focusing drive coil under a non-driven condition.

8. The optical head device as set forth in claim 5 wherein the lens holder is supported by a plurality of wires attached to the holder support member, the wires having predetermined spring constants to allow the lens holder to move in the tracking and in the focusing directions.
